(19) United States
(12) Patent Application Publication
(10) Pub. No.: US 2026/0159712 A1
(43) Pub. Date: Jun. 11, 2026

(54) DEGRADABLE CELLULOSE NANOCRYSTAL-BASED CONDUCTIVE INK AND PREPARATION METHOD THEREOF

(71) Applicant: Beijing Institute Of Graphic Communication, Beijing (CN)

(72) Inventors: Meijuan CAO, Beijing (CN); Ji YANG, Beijing (CN); Yuansheng QI, Beijing (CN); Xiangjun GUO, Beijing (CN); Xuan JI, Beijing (CN); Xinyu JI, Beijing (CN); Shasha LI, Beijing (CN); Lei XUE, Beijing (CN); Luyao WANG, Beijing (CN); Luhai LI, Beijing (CN); Zhicheng SUN, Beijing (CN); Ruping LIU, Beijing (CN); Lixin MO, Beijing (CN)

(21) Appl. No.: 18/971,738

(22) Filed: Dec. 6, 2024

(51) Int. Cl. C09D 11/52; C09D 11/322; C09D 11/38

(52) U.S. Cl. CPC C09D 11/52; C09D 11/322; C09D 11/38

(57) ABSTRACT

A degradable cellulose nanocrystal-based conductive ink and a preparation method thereof are provided. The preparation method includes: S1, dissolving a cellulose nanocrystal in deionized water to form a mixed solution, and adding a water-resistant modifier into the mixed solution, and subjecting a resulting mixture to ultrasonic full dispersion to obtain a dispersion for later use; S2, dissolving a graphene nanopowder, methyl orange, polyvinyl pyrrolidone (PVP), and pyrrole in deionized water to obtain a suspension for later use; S3, adding an acidified ferric chloride solution and the dispersion dropwise into the suspension, subjecting a resulting mixture to a full reaction, subjecting a resulting hot reaction solution to suction filtration, and drying, and o grinding fully a resulting dried mixture to obtain a conductive filler; and S4, mixing the conductive filler, terpineol, glycerol, and PVA fully to obtain the degradable cellulose nanocrystal-based conductive ink.

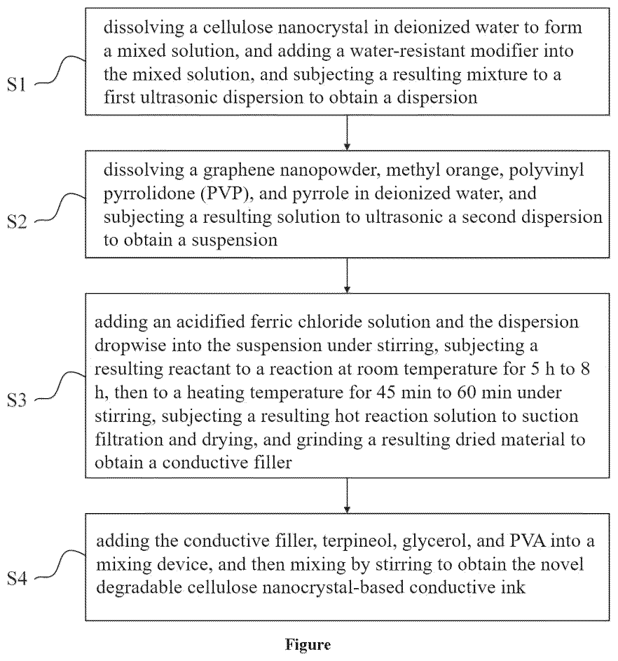

### TECHNICAL FIELD

The present disclosure belongs to the technical field of conductive inks, and in particular to a degradable cellulose nanocrystal-based conductive ink and a preparation method thereof.

### BACKGROUND

Wearable smart devices (or wearable devices) refer to smart devices that integrate computer or electronic technology into daily life by being worn on the body. Some existing commercial products include wearable smart glasses, gloves, watches, clothing, and shoes, etc. Such devices can be linked with other smart devices to achieve functions such as data exchange and monitoring of physiological indicators.

Wearable devices generally adopt flexible conductive devices. The flexible conductive devices comprise flexible conductive materials that exhibit both high mechanical properties and desirable conductive properties. A flexible circuit formed by printing a conductive ink is a type of the flexible conductive materials with broad application prospects. Conductive circuits formed by printing conventional conductive inks made of metal conductive powder and binder have the following problems: poor mechanical properties, low fracture limit strain, easy damage during reciprocating bending and stretching, and poor durability. Moreover, these conductive circuits are not environmentally friendly enough, since conventional conductive inks have the defects of volatile organic matter emissions and are difficult to degrade after disposal.

Cellulose nanocrystals (or nanocellulose) are ultrafine fibers with a diameter of less than 100 nm, and have the characteristics of natural cellulose such as light weight, degradability, biocompatibility, and renewability. Therefore, the cellulose nanocrystals exhibit great potential application prospects in the fields of papermaking, construction, automobiles, food, cosmetics, electronic products, and medicine. In view of the above-mentioned deficiencies of conductive inks, no precedent for forming a novel conductive ink using cellulose nanocrystals, conductive components, and adhesive components has been reported in the prior art.

### SUMMARY

A technical problem to be solved by the present disclosure is to provide a degradable cellulose nanocrystal-based conductive ink and a preparation method thereof, to overcome the shortcomings of the existing conductive circuit forming by conductive ink printing, such as poor mechanical properties, low durability, difficulty in conductive ink degradation, and poor environmental friendliness.

Technical solutions of the present disclosure to solve the above technical problems are as follows:

The present disclosure provides a method for preparing a degradable cellulose nanocrystal-based conductive ink, including the following steps:
S1, dissolving a cellulose nanocrystal in deionized water to form a mixed solution, and adding a water-resistant modifier into the mixed solution, and subjecting a resulting mixture to a first ultrasonic dispersion to obtain a dispersion for later use;
S2, dissolving a graphene nanopowder, methyl orange, polyvinyl pyrrolidone (PVP), and pyrrole in deionized water, and subjecting a resulting solution to a second ultrasonic dispersion to obtain a suspension for later use;
S3, adding an acidified ferric chloride solution and the dispersion obtained in step S1 dropwise into the suspension obtained in step S2 under stirring, subjecting a resulting reactant to a reaction at room temperature for 5 h to 8 h, then heating to 78° C. to 85° C. under rapid stirring, continuing stirring and holding at the temperature of 78° C. to 85° C. for 45 min to 60 min, subjecting a resulting hot reaction solution to suction filtration, and drying, and grinding fully a resulting dried material to obtain a conductive filler; and
S4, adding 10 parts to 15 parts by weight of the conductive filler obtained in step S3, 80 parts to 120 parts by weight of terpineol, 10 parts to 20 parts by weight of glycerol, and 15 parts to 30 parts by weight of PVA into a mixing device, and then mixing by stirring thoroughly to obtain the degradable cellulose nanocrystal-based conductive ink.

The present disclosure may further make the following improvements based on the above technical solutions.

In some embodiments, the dispersion in step S1 includes 6 mg/mL to 8 mg/mL of the cellulose nanocrystal and 1 mg/mL to 2 mg/mL of the water-resistant modifier.

In some embodiments, the water-resistant modifier is methyltrimethoxysilane (MTMS).

In some embodiments, in step S2, a mass ratio of the graphene nanopowder, the methyl orange, the PVP, and the pyrrole is in a range of (3-6):(8-12):(15-30):(2-5), and the suspension includes 10 mg/mL to 15 mg/mL of the graphene nanopowder.

In some embodiments, the acidified ferric chloride solution in step S3 includes 0.1 mol/L to 0.5 mol/L of ferric chloride, and has a pH value of 0.5 to 1. In the reaction solution after the dropwise adding is completed, a mass ratio of the ferric chloride to the pyrrole is in a range of approximately 0.3:1 to 0.6:1.

In some embodiments, the acidified ferric chloride solution in step S3 is acidified using hydrochloric acid.

In some embodiments, the grinding fully in step S3 is performed by ball milling at a speed of 3,500 r/min to 4,000 r/min for 60 seconds(s) to 120 s in a high-speed vibration ball mill.

In some embodiments, the mixing by stirring thoroughly in step S4 is performed by stirring at a speed of 4,000 r/min to 5,000 r/min for 10 min to 15 min in the mixing device.

In some embodiments, the graphene nanopowder has a size in all dimensions of not more than 100 nm.

The present disclosure further provides a degradable cellulose nanocrystal-based conductive ink prepared by the preparation method.

Compared with the prior art, beneficial effects of some embodiments of the present disclosure are as follows:

In the present disclosure, modification of the cellulose nanocrystal and synthesis of conductive polypyrrole in a characteristic form are conducted simultaneously by a one-pot method. While forming the hollow conductive polypyrrole, a resulting modified cellulose nanocrystal can be partially filled in a hollow cavity of the conductive polypyrrole to a certain extent. Moreover, the graphene nanopowder in reaction raw materials is also distributed on a surface and cavity of the conductive polypyrrole, ensuring that the obtained conductive filler shows both high conductivity and desirable mechanical properties, and ensuring that a resulting printed flexible circuit can withstand a certain degree of repeated bending or pulling without damage. Moreover, the cellulose after being modified by MTMS shows enhanced water resistance, such that the formed flexible circuit shows improved water resistance. In addition, the cellulose nanocrystal, graphene nanopowder, and polypyrrole all have a certain degree of degradability, such that the conductive ink formed exhibits desirable environmental friendliness.

### BRIEF DESCRIPTION OF THE DRAWINGS

FIGURE shows a flow chart of the method for preparing a degradable cellulose nanocrystal-based conductive ink according to an embodiment of the present disclosure.

### DETAILED DESCRIPTION OF THE EMBODIMENTS

The principles and features of the present disclosure are described below with reference to the accompanying drawings and examples. The listed examples are only used to explain the present disclosure, rather than to limit the scope of the present disclosure.

To avoid redundancy, drugs used in the following examples are all commercially available drugs unless otherwise specified, and methods used are all conventional methods in the art unless otherwise specified. The graphene nanopowder is obtained by synthesizing graphene sheets with a thickness of not more than 20 nm by mechanical exfoliation or chemical synthesis and then high-speed ball milling such that their sizes in all dimensions are not more than 100 nm.

The present disclosure provides a degradable cellulose nanocrystal-based conductive ink, where a process flow of the preparation method thereof is shown in the FIGURE.

### EXAMPLE 1

A method for preparing a degradable cellulose nanocrystal-based conductive ink was conducted by the following steps:
S1, a cellulose nanocrystal was dissolved in deionized water to form a mixed solution, and a water-resistant modifier was added into the mixed solution. A resulting mixture was subjected to ultrasonic full dispersion to obtain a dispersion for later use, where in the dispersion a concentration of the cellulose nanocrystal was 6 mg/mL and a concentration of the water-resistant modifier MTMS was 1 mg/mL.
S2, a graphene nanopowder, methyl orange, PVP, and pyrrole were dissolved in deionized water. A resulting solution was subjected to ultrasonic full dispersion to obtain a suspension for later use, where a mass ratio of the graphene nanopowder, the methyl orange, the PVP, and the pyrrole was 3:8:15:2, and a concentration of the graphene nanopowder in the suspension was 10 mg/mL.
S3, an acidified ferric chloride solution (with a concentration of hydrochloric acid-acidified ferric chloride being 0.15 mol/L, and a pH value of 0.5) and the dispersion obtained in step S1 were added dropwise into the suspension obtained in step S2 under stirring, where a mass of the ferric chloride in a reactant solution was about 0.3 times that of a mass of the pyrrole. The reactant solution was subjected to reaction at room temperature for 8 h, then heated to 78° C. under rapid stirring, continued stirring and held at the 78° C. for 60 min. A resulting hot reaction solution was subjected to suction filtration and drying. A resulting dried material was placed in a small high-speed vibration ball mill, and then fully grounded by ball milling at a speed of 3,500 r/min for 120 s to obtain a conductive filler.
S4, 10 parts by weight of the conductive filler obtained in step S3, 80 parts to by weight of terpineol, 10 parts to by weight of glycerol, and 15 parts to by weight of PVA were added into a mixing device, and then mixed by stirring thoroughly at a speed of 4,000 r/min for 15 min to obtain the degradable cellulose nanocrystal-based conductive ink.

### EXAMPLE 2

A method for preparing a degradable cellulose nanocrystal-based conductive ink was conducted by the following steps:
S1, a cellulose nanocrystal was dissolved in deionized water to form a mixed solution, and a water-resistant modifier was added into the mixed solution. A resulting mixture was subjected ultrasonic full dispersion to obtain a dispersion for later use, where in the dispersion a concentration of the cellulose nanocrystal was 8 mg/mL and a concentration of the water-resistant modifier MTMS was 2 mg/mL.
S2, a graphene nanopowder, methyl orange, PVP, and pyrrole were dissolved in deionized water. A resulting solution was subjected to ultrasonic full dispersion to obtain a suspension for later use, where a mass ratio of the graphene nanopowder, the methyl orange, the PVP, and the pyrrole was 6:12:30:5, and a concentration of the graphene nanopowder in the suspension was 15 mg/mL.
S3, an acidified ferric chloride solution (with a concentration of hydrochloric acid-acidified ferric chloride being 0.2 mol/L and a pH value being 0.5) and the dispersion obtained in step S1 were added dropwise into the suspension obtained in step S2 under stirring, where a mass of the ferric chloride in a reactant solution was about 0.4 times that of a mass of the pyrrole. The reactant solution was subjected to reaction at room temperature for 6 h, then heated to 80° C. under rapid stirring, continued stirring and held at the 80° C. for 55 min. A resulting hot reaction solution was subjected to suction filtration and drying. A resulting dried material was placed in a small high-speed vibration ball mill, and then fully ground by ball milling at a speed of 4,000 r/min for 60 s to obtain a conductive filler.
S4, 15 parts by weight of the conductive filler obtained in step S3, 120 parts to by weight of terpineol, 20 parts to by weight of glycerol, and 30 parts to by weight of PVA were added into a mixing device, and then mixed by stirring thoroughly at a speed of 4,000 r/min for 15 min to obtain the degradable cellulose nanocrystal-based conductive ink.

### EXAMPLE 3

A method for preparing a degradable cellulose nanocrystal-based conductive ink was conducted by the following steps:
S1, a cellulose nanocrystal was dissolved in deionized water to form a mixed solution, and a water-resistant modifier was added into the mixed solution. A resulting mixture was subjected ultrasonic full dispersion to obtain a dispersion for later use, where in the dispersion a concentration of the cellulose nanocrystal was 7 mg/mL and a concentration of the water-resistant modifier MTMS was 1.5 mg/mL.
S2, a graphene nanopowder, methyl orange, PVP, and pyrrole were dissolved in deionized water. A resulting solution was subjected to ultrasonic full dispersion to obtain a suspension for later use, where a mass ratio of the graphene nanopowder, the methyl orange, the PVP, and the pyrrole was 4:10:22:3, and a concentration of the graphene nanopowder in the suspension was 12 mg/mL.
S3, an acidified ferric chloride solution (with a concentration of hydrochloric acid-acidified ferric chloride being 0.1 mol/L, and a pH value being 1) and the dispersion obtained in step S1 were added dropwise into the suspension obtained in step S2 under stirring, where a mass of the ferric chloride in a reactant solution was about 0.6 times that of a mass of the pyrrole. The reactant solution was subjected to reaction at room temperature for 8 h, then heated to 85° C. under rapid stirring, continued stirring and held at the 85° C. for 45 min. A resulting hot reaction solution was subjected to suction filtration and drying. A resulting dried material was placed in a small high-speed vibration ball mill, and then fully ground by ball milling at a speed of 3,500 r/min for 120 s to obtain a conductive filler.
S4, 12 parts by weight of the conductive filler obtained in step S3, 85 parts to by weight of terpineol, 15 parts to by weight of glycerol, and 20 parts to by weight of PVA were added into a mixing device, and then mixed by stirring thoroughly at a speed of 5,000 r/min for 13 min to obtain the degradable cellulose nanocrystal-based conductive ink.

### EXAMPLE 4

A method for preparing a degradable cellulose nanocrystal-based conductive ink was conducted by the following steps:
S1, a cellulose nanocrystal was dissolved in deionized water to form a mixed solution, and a water-resistant modifier was added into the mixed solution. A resulting mixture was subjected ultrasonic full dispersion to obtain a dispersion for later use, where in the dispersion a concentration of the cellulose nanocrystal was 8 mg/mL and a concentration of the water-resistant modifier MTMS was 1 mg/mL.
S2, a graphene nanopowder, methyl orange, PVP, and pyrrole were dissolved in deionized water. A resulting mixture was subjected to ultrasonic full dispersion to obtain a suspension for later use, where a mass ratio of the graphene nanopowder, the methyl orange, the PVP, and the pyrrole was 3:12:15:5, and a concentration of the graphene nanopowder in the suspension was 10 mg/mL.
S3, an acidified ferric chloride solution (with a concentration of hydrochloric acid-acidified ferric chloride being 0.3 mol/L, and a pH value being 1) and the dispersion obtained in step S1 were added dropwise into the suspension obtained in step S2 under stirring, where a mass of the ferric chloride in a reactant solution was about 0.5 times that of a mass of the pyrrole. The reactant solution was subjected to reaction at room temperature for 5 h, then heated to 85° C. under rapid stirring, continued stirring and held at the 85° C. for 50 min. A resulting hot reaction solution was subjected to suction filtration and drying. A resulting dried material was placed in a small high-speed vibration ball mill, and then fully ground by ball milling at a speed of 3,800 r/min for 100 s to obtain a conductive filler.
S4, 10 parts by weight of the conductive filler obtained in step S3, 120 parts to by weight of terpineol, 20 parts to by weight of glycerol, and 25 parts to by weight of PVA were added into a mixing device, and then mixed by stirring thoroughly at a speed of 5,000 r/min for 15 min to obtain the degradable cellulose nanocrystal-based conductive ink.

### COMPARATIVE EXAMPLE 1

This comparative example was conducted as described in Example 1 except that step S1 was omitted and the dispersion in S3 was replaced by an equal volume of deionized water.

### COMPARATIVE EXAMPLE 2

This comparative example was conducted as described in Example 2 except that step S1 was omitted and the dispersion in S3 was replaced by an equal volume of deionized water.

### COMPARATIVE EXAMPLE 3

This comparative example was conducted as described in Example 5 except that step S1 was omitted and the dispersion in S3 was replaced by an equal volume of deionized water.

### COMPARATIVE EXAMPLE 4

This comparative example was conducted as described in Example 4 except that step 1 was omitted and the dispersion in S3 was replaced by an equal volume of deionized water.

### Performance Test

Conductivities of the conductive inks prepared in Examples 1 to 4 were tested, and found that the conductivities were all above 0.86 S/cm. Conductivities of the conductive inks prepared in Comparative Examples 1 to 4 were tested and found that the conductivities were all above 0.72 S/cm and were lower than those in the Examples 1 to 4. The conductive inks of the examples and the comparative examples were coated onto a paper substrate or a PET substrate, with a substrate thickness of 0.5 mm to 1 mm, to form multiple sets of conductive circuits. Where the coated ink layer has a thickness of 0.1 mm to 0.25 mm and a width of 4 mm to 5 mm. After testing, the conductive circuits formed in the examples were subjected dried, cured, and repeatedly bent (at a bending degree of 60° to 75°) 1,200 times. Resistance values of the conductive circuits have no significant change. Then, the conductive circuits on the PET substrate were stretched 2% to 5% together with the PET substrate and then restored. Stretching and restoring process was repeated 200 times. The resistance values of the conductive circuits have no significant change. In contrast, the conductive circuits corresponding to the comparative examples were bent and stretched to the same degree. After 800 times of bending, the conductive resistance began to increase. When the bending was conducted 1,000 times, some conductive circuits were completely damaged. Resistance of the conductive circuit increased when being stretched 50 times. When being stretched 80 times, some conductive circuits were completely damaged.

The above descriptions are merely preferred embodiments of the present disclosure, and are not intended to limit the present disclosure. Any modifications, equivalent replacements, improvements, and the like made within the spirit and principle of the present disclosure shall be all included in the scope of the present disclosure.

What is claimed is:

1. A method for preparing a degradable cellulose nanocrystal-based conductive ink, comprising:
S1, dissolving a cellulose nanocrystal in deionized water to form a mixed solution, and adding a water-resistant modifier into the mixed solution, and subjecting a resulting mixture to a first ultrasonic dispersion to obtain a dispersion;
S2, dissolving a graphene nanopowder, methyl orange, polyvinyl pyrrolidone (PVP), and pyrrole in deionized water, and subjecting a resulting solution to a second ultrasonic dispersion to obtain a suspension;
S3, adding an acidified ferric chloride solution and the dispersion obtained in step S1 dropwise into the suspension obtained in step S2 under stirring, subjecting a resulting reactant to a reaction at room temperature for 5 h to 8 h, then heating to a temperature of 78° C. to 85° C. under stirring, continuing stirring and holding at the temperature of 78° C. to 85° C. for 45 min to 60 min, subjecting a resulting hot reaction solution to suction filtration and drying, and grinding a resulting dried material to obtain a conductive filler; and
S4, adding 10 parts to 15 parts by weight of the conductive filler obtained in step S3, 80 parts to 120 parts by weight of terpineol, 10 parts to 20 parts by weight of glycerol, and 15 parts to 30 parts by weight of PVA into a mixing device, and then mixing by stirring to obtain the degradable cellulose nanocrystal-based conductive ink.

2. The method for preparing the degradable cellulose nanocrystal-based conductive ink according to claim 1, wherein the dispersion obtained in step S1 comprises 6 mg/mL to 8 mg/mL of the cellulose nanocrystal and 1 mg/mL to 2 mg/mL of the water-resistant modifier.

3. The method for preparing the degradable cellulose nanocrystal-based conductive ink according to claim 1, wherein the water-resistant modifier is methyltrimethoxysilane (MTMS).

4. The method for preparing the degradable cellulose nanocrystal-based conductive ink according to claim 1, wherein in step S2, a mass ratio of the graphene nanopowder, the methyl orange, the PVP, and the pyrrole is in a range of 3-6:8-12:15-30:2-5, and the suspension comprises 10 mg/mL to 15 mg/mL of the graphene.

5. The method for preparing the degradable cellulose nanocrystal-based conductive ink according to claim 1, wherein the acidified ferric chloride solution in step S3 comprises 0.1 mol/L to 0.5 mol/L of ferric chloride, and has a pH value of 0.5 to 1.

6. The method for preparing the degradable cellulose nanocrystal-based conductive ink according to claim 1, wherein the acidified ferric chloride solution in step S3 is acidified using hydrochloric acid.

7. The method for preparing the degradable cellulose nanocrystal-based conductive ink according to claim 1, wherein the grinding in step S3 is performed by ball milling at a speed of 3,500 r/min to 4,000 r/min for 60 s to 120 s in a vibration ball mill.

8. The method for preparing the degradable cellulose nanocrystal-based conductive ink according to claim 1, wherein the mixing by stirring in step S4 is performed by stirring at a speed of 4,000 r/min to 5,000 r/min for 10 min to 15 min in the mixing device.

9. The method for preparing the degradable cellulose nanocrystal-based conductive ink according to claim 2, wherein the mixing by stirring in step S4 is performed by stirring at a speed of 4,000 r/min to 5,000 r/min for 10 min to 15 min in the mixing device.

10. The method for preparing the degradable cellulose nanocrystal-based conductive ink according to claim 3, wherein the mixing by stirring in step S4 is performed by stirring at a speed of 4,000 r/min to 5,000 r/min for 10 min to 15 min in the mixing device.

11. The method for preparing the degradable cellulose nanocrystal-based conductive ink according to claim 4, wherein the mixing by stirring in step S4 is performed by stirring at a speed of 4,000 r/min to 5,000 r/min for 10 min to 15 min in the mixing device.

12. The method for preparing the degradable cellulose nanocrystal-based conductive ink according to claim 5, wherein the mixing by stirring in step S4 is performed by stirring at a speed of 4,000 r/min to 5,000 r/min for 10 min to 15 min in the mixing device.

13. The method for preparing the degradable cellulose nanocrystal-based conductive ink according to claim 6, wherein the mixing by stirring in step S4 is performed by stirring at a speed of 4,000 r/min to 5,000 r/min for 10 min to 15 min in the mixing device.

14. The method for preparing the degradable cellulose nanocrystal-based conductive ink according to claim 7, wherein the mixing by stirring in step S4 is performed by stirring at a speed of 4,000 r/min to 5,000 r/min for 10 min to 15 min in the mixing device.

15. The method for preparing the degradable cellulose nanocrystal-based conductive ink according to claim 8, wherein the graphene nanopowder has a size in all dimensions of not more than 100 nm.

16. A degradable cellulose nanocrystal-based conductive ink prepared by the method according to claim 1.

17. The degradable cellulose nanocrystal-based conductive ink of claim 16, wherein the dispersion obtained in step S1 comprises 6 mg/mL to 8 mg/mL of the cellulose nanocrystal and 1 mg/mL to 2 mg/mL of the water-resistant modifier.

18. The degradable cellulose nanocrystal-based conductive ink of claim 16, wherein the water-resistant modifier is methyltrimethoxysilane (MTMS).

19. The degradable cellulose nanocrystal-based conductive ink of claim 16, wherein in step S2, a mass ratio of the graphene nanopowder, the methyl orange, the PVP, and the pyrrole is in a range of 3-6:8-12:15-30:2-5, and the suspension comprises 10 mg/mL to 15 mg/mL of the graphene.

20. The degradable cellulose nanocrystal-based conductive ink of claim 16, wherein the acidified ferric chloride solution in step S3 comprises 0.1 mol/L to 0.5 mol/L of ferric chloride, and has a pH value of 0.5 to 1.
